(19) United States
(12) Patent Application Publication
(10) Pub. No.: US 2007/0091870 A1
(43) Pub. Date: Apr. 26, 2007

(54) Method and system for releasing a TIF session for a SIP agent when a call process interface handler is interrupted

(75) Inventors: Angela Hsu, Plano, TX (US); Xiangying Meng, Allen, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/254,333

(22) Filed: Oct. 20, 2005

(51) Int. Cl. H04L 12/66

(52) U.S. Cl. 370/352; 370/401

(57) ABSTRACT

A method for releasing a Session Initiation Protocol (SIP) call that has been established as a TP Interface Function (TIF) session when a call process interface handler is interrupted is provided. The method includes storing at least one identifier for the session in an application layer gateway when the session is established. For a particular embodiment, the at least one identifier comprises a connection identifier and a connection endpoint identifier.

### TECHNICAL FIELD OF THE INVENTION

The present disclosure relates generally to wireless networks and, more specifically, to a method and system for releasing a TP Interface Function (TIF) session for a Session Initiation Protocol (SIP) agent when a call process interface handler is interrupted.

### BACKGROUND OF THE INVENTION

When a call process interface handler is interrupted due to malfunction or other problems and subsequently restarts, any Session Initiation Protocol (SIP) call in a TP Interface Function (TIF) session will hang. The TIF session will not be released until the TIF restarts. Because of this, the TIF process may not be as reliable as desired.

Therefore, there is a need in the art for a method of releasing a TIF session for a SIP agent when the call process interface handler is interrupted and restarts.

### SUMMARY OF THE INVENTION

A method for releasing a TP Interface Function (TIF) session for a Session Initiation Protocol (SIP) agent when a call process interface handler is interrupted is provided. According to an advantageous embodiment of the present disclosure, the method includes storing at least one identifier for the session in an application layer gateway when the session is established.

According to one embodiment of the present disclosure, the at least one identifier comprises a connection identifier.

According to another embodiment of the present disclosure, the at least one identifier further comprises a connection endpoint identifier.

According to still another embodiment of the present disclosure, the method also includes receiving a setup request from a SIP agent, sending the setup request to the call process interface handler, and receiving a setup response that comprises the at least one identifier from the call process interface handler based on the setup request.

According to yet another embodiment of the present disclosure, the method also includes receiving a termination request from a SIP agent, retrieving the at least one identifier based on the termination request, including the at least one identifier in the termination request, and sending the termination request including the at least one identifier to the call process interface handler.

According to a further embodiment of the present disclosure, the method also includes releasing the session based on the at least one identifier included in the termination request.

According to still a further embodiment of the present disclosure, the method also includes receiving a termination response from the call process interface handler based on the release of the session and sending the termination response to the SIP agent.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the term “each” means every one of at least a subset of the identified items; and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary communication network that is capable of releasing a TP Interface Function (TIF) session for a Session Initiation Protocol (SIP) agent when a call process interface handler is interrupted according to an embodiment of the present disclosure;

FIG. 2 is a flow diagram illustrating a method for establishing a SIP call as a TIF session such that the TIF session may be released when the call process interface handler is interrupted according to an embodiment of the present disclosure; and

FIG. 3 is a flow diagram illustrating a method for releasing a SIP call that has been established as a TIF session when the call process interface handler is interrupted according to an embodiment of the present disclosure.

### DETAILED DESCRIPTION OF THE INVENTION

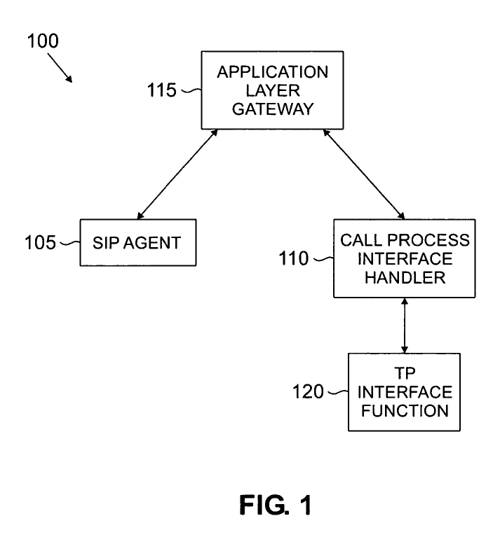

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication network.

FIG. 1 illustrates an exemplary communication network 100 that is capable of releasing a TP Interface Function (TIF) session for a Session Initiation Protocol (SIP) agent 105 when a call process interface handler 110 is interrupted according to an embodiment of the present disclosure. In addition to SIP agent 105 and call process interface handler 110, communication network 100 comprises an application layer gateway 115 and a TP interface function 120. It will be understood that communication network 100 may comprise components other than those illustrated in FIG. 1.

SIP agent 105 may comprise a SIP phone or any other device capable of communicating using SIP and communicating in a TIF session. Although a single SIP agent 105 is illustrated in FIG. 1, it will be understood that communication network 100 may comprise any suitable number of SIP agents 105 without departing from the scope of the present disclosure. Call process interface handler 110 is operable to assist in the establishment of a TIF session for SIP agent 105 when SIP agent 105 requests a call setup. Application layer gateway 115 is operable to provide access to components in communication network 100, such as call process interface handler 110 and other suitable components (not shown in FIG. 1). TP interface function 120 is operable to establish and release TIF sessions for SIP agent 105.

As described in more detail below, communication network 100 is operable to allow the release of a TIF session for SIP agent 105 when call process interface handler 110 is interrupted and restarts. In order to accomplish this, application layer gateway 115 is operable to store a connection identifier and a connection endpoint identifier for the TIF session. Thus, in the event of a restart of call process interface handler 110, application layer gateway 115 is operable to provide the connection identifier and the connection endpoint identifier to call process interface handler 110, which is operable to provide the identifiers to TP interface function 120 for use in releasing the TIF session.

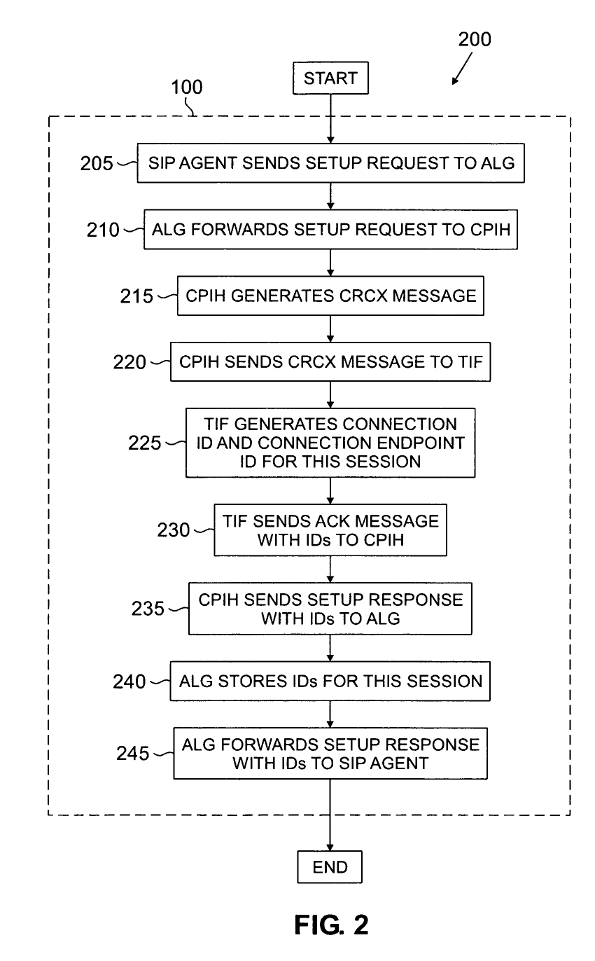

FIG. 2 is a flow diagram illustrating a method 200 for establishing a SIP call as a TIF session such that the TIF session may be released when call process interface handler 110 is interrupted according to an embodiment of the present disclosure. Initially, SIP agent 105 sends a setup request (e.g., an INVITE message) to application layer gateway (ALG) 115 (process step 205).

Application layer gateway 115 forwards the setup request to call process interface handler (CPIH) 110 (process step 210). Based on the setup request, call process interface handler 110 generates a create connection (CRCX) message (process step 215) and sends the CRCX message to TP interface function (TIF) 120 (process step 220).

In response to the CRCX message, TP interface function 120 generates a connection identifier (ID) and a connection endpoint identifier for this particular session (process step 225). TP interface function 120 then sends an acknowledgement (ACK) message that comprises the connection identifier and the connection endpoint identifier to call process interface handler 110 (process step 230).

Based on the acknowledgement message, call process interface handler 110 sends a setup response that comprises the connection identifier and the connection endpoint identifier to application layer gateway 115 (process step 235). The setup response may comprise a 200 OK message or other type of message that indicates the requested transaction was successfully completed. Application layer gateway 115 stores the connection identifier and the connection endpoint identifier for this session (process step 240) and forwards the setup response to SIP agent 105 (process step 245).

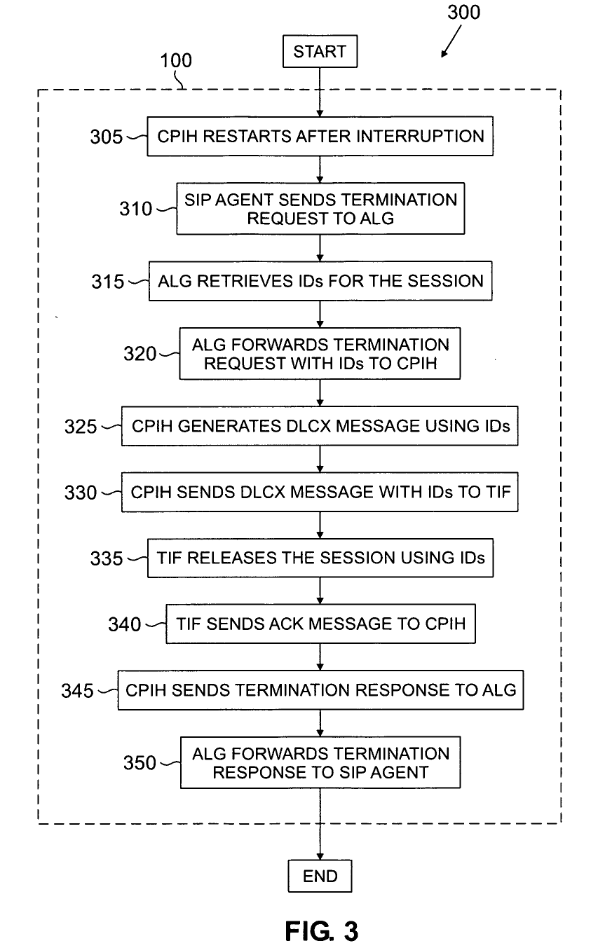

Thus, both the connection identifier and the connection endpoint identifier are stored in application layer gateway 115 after the session has been established. Using these stored identifiers, communication network 100 may release the TIF session after an interruption and restart of call process interface handler 110, as described in more detail below in connection with FIG. 3.

FIG. 3 is a flow diagram illustrating a method 300 for releasing a SIP call that has been established as a TIF session when call process interface handler 110 is interrupted according to an embodiment of the present disclosure. Initially, an interruption has occurred in call process interface handler 110 while call process interface handler 110 is servicing a TIF session for SIP agent 105 and call process interface handler 110 has restarted (process step 305). For example, call process interface handler 110 may have experienced a malfunction, a power failure, or any other type of interruption in call process interface handler's 110 ability to provide continuous service to SIP agent 105 during the TIF session.

SIP agent 105 then sends a termination request (e.g., a BYE message) to application layer gateway 115 (process step 310). In response to the termination request, application layer gateway 115 retrieves the connection identifier and the connection endpoint identifier which were stored in application layer gateway 115 when the TIF session was established (process step 315). Application layer gateway 115 then includes the identifiers in the termination request and forwards the termination request with the identifiers to call process interface handler 110 (process step 320).

Call process interface handler 110 generates a delete connection (DLCX) message using the identifiers in the termination request (process step 325) and sends the DLCX message with the identifiers to TP interface function 120 (process step 330). Using the identifiers, TP interface function 120 releases the session (process step 335).

TP interface function 120 then sends an acknowledgement message to call process interface handler 110 (process step 340). Based on the acknowledgement, call process interface handler 110 sends a termination response to application layer gateway 115 (process step 345). The termination response may comprise a 200 OK message or other type of message that indicates the requested transaction was successfully completed. Finally, application layer gateway 115 forwards the termination response to SIP agent 105. Thus, using the connection identifier and the connection endpoint identifier stored in application layer gateway 115, TP interface function 120 is able to release the TIF session when call process interface handler 110 restarts after an interruption.

While several embodiments have been provided in the present disclosure, it should be understood that the disclosed systems and methods may be embodied in many other specific forms without departing from the spirit or scope of the present disclosure. The exemplary embodiments disclosed are to be considered as illustrative and not restrictive, and the intention is not to be limited to the details given herein. It is intended that the disclosure encompass all alternate forms within the scope of the appended claims along with their full scope of equivalents.

What is claimed is:

1. A method for releasing a Session Initiation Protocol (SIP) call that has been established as a TP Interface Function (TIF) session when a call process interface handler is interrupted, comprising:
storing at least one identifier for the session in an application layer gateway when the session is established.

2. The method as set forth in claim 1, the at least one identifier comprising a connection identifier.

3. The method as set forth in claim 2, the at least one identifier further comprising a connection endpoint identifier.

4. The method as set forth in claim 1, further comprising:
receiving a setup request from a SIP agent;
sending the setup request to the call process interface handler; and
receiving a setup response from the call process interface handler based on the setup request, the setup response comprising the at least one identifier.

5. The method as set forth in claim 1, further comprising:
receiving a termination request from a SIP agent;
retrieving the at least one identifier based on the termination request;
including the at least one identifier in the termination request; and
sending the termination request including the at least one identifier to the call process interface handler.

6. The method as set forth in claim 5, further comprising releasing the session based on the at least one identifier included in the termination request.

7. The method as set forth in claim 6, further comprising:
receiving a termination response from the call process interface handler based on the release of the session; and
sending the termination response to the SIP agent.

8. A method for releasing a Session Initiation Protocol (SIP) call that has been established as a TP Interface Function (TIF) session when a call process interface handler is interrupted, comprising:
retrieving at least one stored identifier for the session when the call process interface handler restarts; and
releasing the session based on the at least one identifier.

9. The method as set forth in claim 8, the at least one identifier comprising a connection identifier.

10. The method as set forth in claim 9, the at least one identifier further comprising a connection endpoint identifier.

11. The method as set forth in claim 8, further comprising:
receiving a termination request from a SIP agent;
retrieving at least one stored identifier when the call process interface handler restarts comprising retrieving the at least one identifier based on the termination request;
including the at least one identifier in the termination request; and
sending the termination request including the at least one identifier to the call process interface handler.

12. The method as set forth in claim 11, further comprising:
sending the termination request including the at least one identifier from the call process interface handler to a TP interface function; and
releasing the session based on the at least one identifier comprising releasing the session at the TP interface function based on the at least one identifier included in the termination request.

13. The method as set forth in claim 12, further comprising:
receiving a termination response from the call process interface handler based on the release of the session; and
sending the termination response to the SIP agent.

14. A system capable of providing the release of a Session Initiation Protocol (SIP) call that has been established as a TP Interface Function (TIF) session when a call process interface handler is interrupted, comprising:
an application layer gateway operable to store at least one identifier for the session when the session is established.

15. The system as set forth in claim 14, the at least one identifier comprising a connection identifier and a connection endpoint identifier.

16. The system as set forth in claim 14, the application layer gateway further operable to receive a setup request from a SIP agent, to send the setup request to the call process interface handler, and to receive a setup response from the call process interface handler based on the setup request, the setup response comprising the at least one identifier.

17. The system as set forth in claim 14, the application layer gateway further operable to receive a termination request from a SIP agent, to retrieve the at least one identifier based on the termination request, to include the at least one identifier in the termination request, and to send the termination request including the at least one identifier to the call process interface handler.

18. The system as set forth in claim 17, further comprising:
the call process interface handler; and
a TP interface function, the call process interface handler operable to send the termination request including the at least one identifier to the TP interface function, and the TP interface function operable to release the session based on the at least one identifier included in the termination request.

19. The system as set forth in claim 18, the call process interface handler further operable to receive an acknowledgement from the TP interface function based on the release of the session, to generate a termination response based on the acknowledgement, and to send the termination response to the application layer gateway.

20. The system as set forth in claim 19, the application layer gateway further operable to receive the termination response from the call process interface handler and to send the termination response to the SIP agent.
